(19) United States
(12) Patent Application Publication
(10) Pub. No.: US 2016/0092602 A1
(43) Pub. Date: Mar. 31, 2016

(54) Customizable Data Services

(71) Applicant: Microsoft Technology Licensing, LLC., Redmond, WA (US)

(72) Inventors: Zhen Liu, Tarrytown, NY (US); Chiu-Chun Bobby Mak, Beijing (CN); Michael Fischer, Beijing (CN); Dafeng Wang, Beijing (CN); Darren Chuang, New Taipei City (TW); Ruifeng Wu, Beijing (CN); Xin Peng, Beijing (CN); Jingmei Jessica Li, Beijing (CN); QingHu Li, Beijing (CN)

(21) Appl. No.: 14/604,711

(22) Filed: Jan. 24, 2015

(30) Foreign Application Priority Data
Sep. 29, 2014 (CN) PCT/CN2014/087758

(51) Int. Cl. G06F 17/30; G06F 3/0481

(52) U.S. Cl. CPC G06F 17/30994; G06F 3/0481; G06F 17/3056

(57) ABSTRACT

Embodiments are directed to methods and systems for defining customizable data services through dynamic configuration of a dashboard using data feeds, analytics, and visual artifacts. A customizable dashboard is built using a basic framework, design time configuration, instantiation time binding, and runtime ad hoc data input. The customizable data service binds business logic in a data query service with a visual tile template that provides specific parameters for visualizations and/or queries. The visual tile templates are pluggable visual on multiple dashboard pages.

### CROSS-REFERENCE TO RELATED APPLICATIONS

This application is a continuation of International Application No. PCT/CN2014/087758, which was filed on Sep. 29, 2014, the disclosure of which is hereby incorporated by reference herein in its entirety.

### BACKGROUND

User interfaces, such as dashboards, may be used to provide access to data sets. These dashboards are often created to display a particular set of key performance indicators (KPIs). Typically, the KPIs are selected and defined prior to dashboard development, and the dashboard is designed specifically for that set of KPIs. Existing dashboards typically target only one set of KPIs and adding new KPIs to an existing dashboard requires further development or creation of an entirely new dashboard.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments are directed to methods and systems for defining customizable data services through dynamic configuration of a dashboard using data feeds, analytics, and visual artifacts. A customizable dashboard is built using a basic framework, design time configuration, instantiation time binding, and runtime ad hoc data input. The customizable data service binds business logic in a data query service with a visual tile template that provides specific parameters for visualizations and/or queries. The visual tile templates are pluggable visual on multiple dashboard pages.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates the architecture and basic framework for a customizable data service according to one embodiment.

FIG. 2 illustrates an example dashboard with a plurality of static tiles.

FIG. 3 illustrates a visualization of a dashboard having multiple levels.

FIG. 4 is flowchart of a process for building a customizable dashboard according to one embodiment.

FIG. 5 illustrates an example of a suitable computing and networking environment for customizable data services.

### DETAILED DESCRIPTION

Businesses can gain insights from abundant data sources. Typically, such data sources are analyzed using various analytical tools and the results presented using different visualization tools. A common way of viewing multiple sets of information is through a dashboard user interface. However, existing dashboards are typically static and do not function in a dynamic way based on business needs and data availability.

Organizations need solutions to compete in a rapidly changing and increasingly data-driven business. Actionable insights can be gained by analyzing large volumes of unstructured data (i.e., “big data”). This big data analysis allows businesses to extract and understand business insights using a variety of data sources and analytics as well as visualization tools. The technologies disclosed herein dynamically adapt to new situations and new streams of data so that users can quickly and easily create new dashboards for any KPIs.

Due to the variety, velocity, and volume of data being received, abundant data sources are dynamic and unstable. A dynamic dashboard that can change and keep up with the data is needed so that users can apply different KPIs to the data.

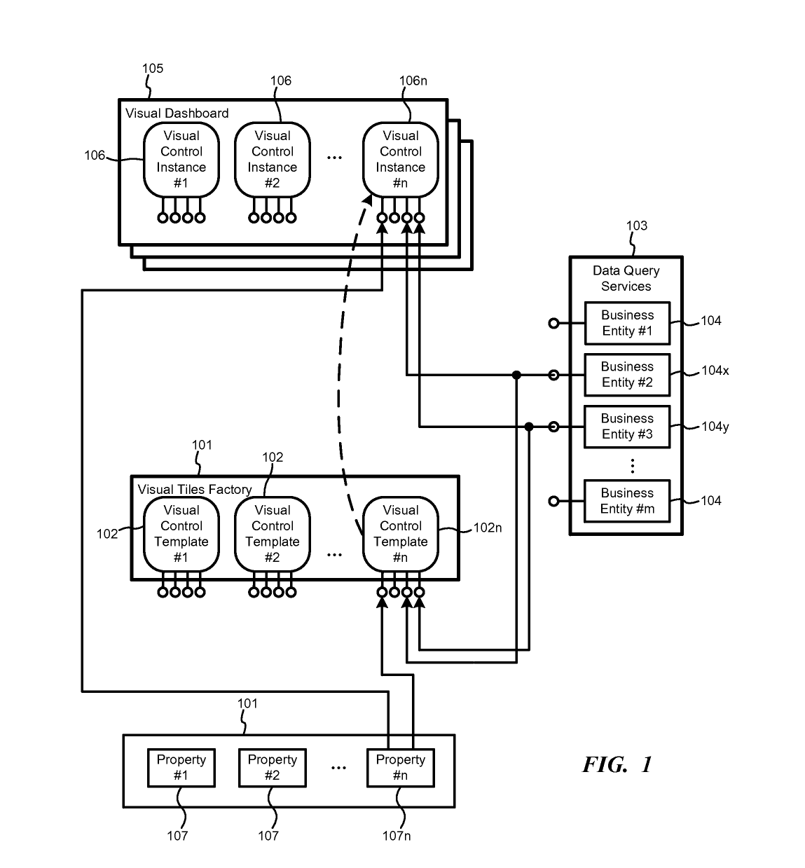

FIG. 1 illustrates the architecture and basic framework for a customizable data service according to one embodiment. This framework includes a combination of Model-View-ViewModel (MVVM) subsets and a Factory pattern implementation. Embodiments connect data, analytics, and visualizations. FIG. 1 provides an example dashboard framework that binds visualizations with back-end data and analytics through user-defined configurations. The dashboard not only supports the visualization of data from the back-end data source, also supports ad hoc data input by end users through the dashboard directly.

Visual tiles factory 101 hosts multiple visual control templates 102 that are used to create user interface tiles. Each visual control template 102 provides custom controls that expose dependency properties for bindings and visualization sub modules. A user may identify different data sources, analytics, and visualizations for each visual control template 102.

Data query services 103 represent multiple business entities 104. Each business entity 104 represents a different encapsulation of a data entity with associated business logic. The business entities 104 expose one or more query endpoints that can be used by a visual control template 102, for example, to collect desired data. Different ones of the business entities 104 may be related to each other, such as sharing a common data source or similar business logic. Alternatively, the business entities 104 may represent different business logic applied to independent data sources.

A user interface designer configures the visual control templates 102 to bind data sources and analytics to visualizations that provide KPIs and/or other information as static tiles on a visual dashboard. The user interface dashboard may be interactive and may support multiple levels so that a user may select a tile, such as by “clicking” on the tile, to access a next level of data. Each level of the user interface may include interactions and analytics. A separate visual control template 102 may be used to configure each level of the user interface dashboard, or one visual control template 102 may define different visualizations for different levels.

Visual dashboard 105 hosts multiple visual control instances 106. At instantiation time, visual tile factory 101 instantiates visual control instances 106 with the bindings, visualization, back-end data, and analytics for each visual control template 102. The bindings may be defined, for example, in properties 107.

At runtime, visual control instances 106 access bind properties 107 and business entities 104 to provide visualization of the data onto the dashboard. In addition to visualization of data from the back-end data query services 103, visual control instances 106 also support ad hoc data input by end users. The end users may input data directly through the dashboard.

For example, a user interface designer may define a dashboard tile by binding visual control template 102n to back-end data and analytics for business entities 104x and 104y. Visual control template 102n defines how the information is displayed on the dashboard. Visual control template 102n may use bindings and/or configurations defined in properties 107n. Visual control template 102n defines how the KPIs and information are displayed as a static tile on a dashboard. Visual control template 102n may also define multiple levels of user interface that include user interactions and analytics.

At instantiation time, visual tile factory 101 instantiates a visual control instance 106n with the bindings, visualization, back end data, and analytics defined in visual control template 102n. At runtime, using the defined bind properties, visual control instance 106n accesses data and analytics from business entities 104x and 104y and provides visualization of the data on to the dashboard. In addition to visualization of data from back-end data sources, visual control instance 106n also supports direct ad hoc data input by end users through the dashboard.

Back-end data provided based on business entity 104 may include any form of data, such as structure, unstructured, created, measured, provoked, transacted, compiled, captured, and/or user-generated data. Analytics may be done using software tools such as predictive analytics, data mining, or other tools for examining large amounts of data of a variety of types to uncover hidden patterns, unknown correlations, and other useful information. The tiles on the dashboard may display the KPIs and analytics information in any format, such as graphs, pie charts, bar charts, weather maps, heat maps, lists, timelines, etc.

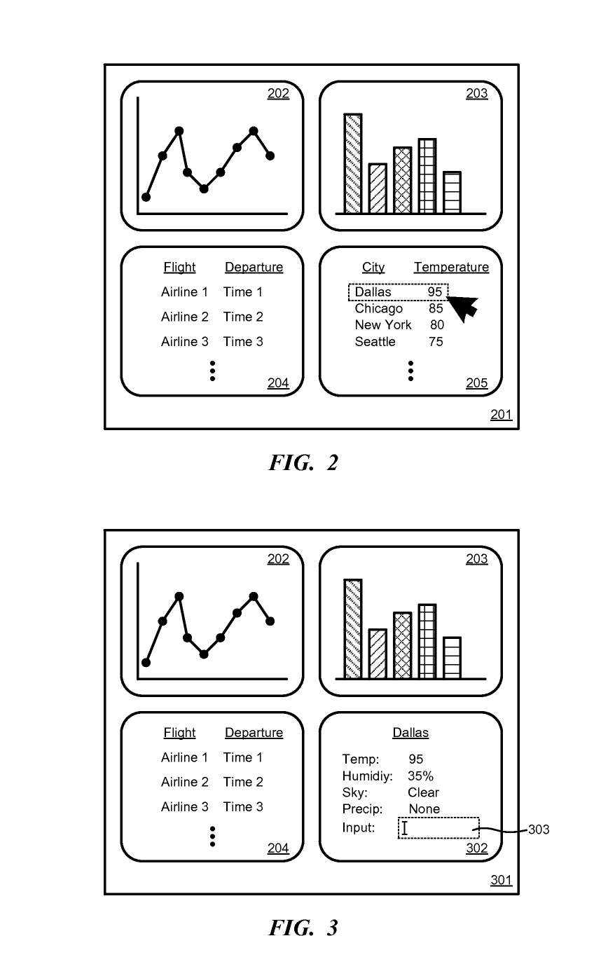

FIG. 2 illustrates an example dashboard 201 with a plurality of static tiles 202-205. Each of the static tiles 202-205 corresponds to a visual control instance that has been instantiated from a visual control template at runtime. Each tile 202-205 provides different data, analytics, and visualizations. For example, tile 202 may be a visualization of stock quote data, tile 203 may be a visualization of sales volumes, tile 204 may be a visualization of airline flight information, and tile 205 may be a visualization of weather data. It will be understood that each tile is bound to a different back-end data source and analytics as defined in a corresponding visual control instance. Each tile 202-205 may also display the data using a different visualization by modifying the visual control instance.

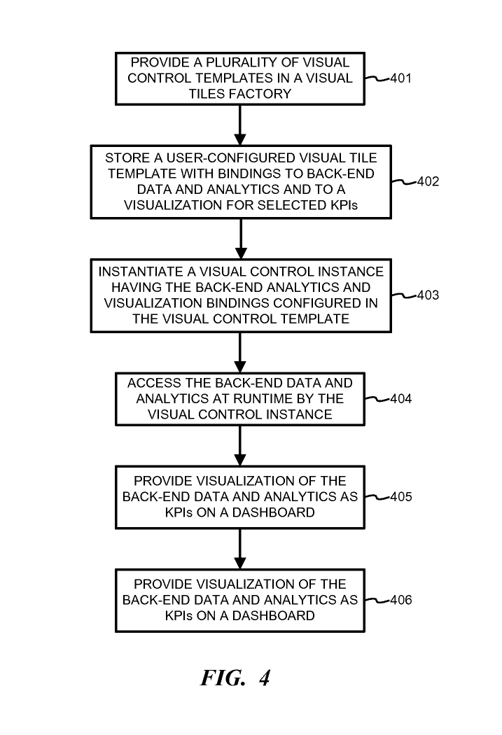

An end-user may select data in one of the tiles to access a next level interface. For example, by selecting an entry for a city in weather tile 205, more detailed information may be displayed using a new visualization as shown on dashboard 301 in tile 302 of FIG. 3.

The end-user may also provide inputs directly to the dashboard. For example, tile 302 on dashboard 301 may include a user input field 303 to allow ad hoc user data entry.

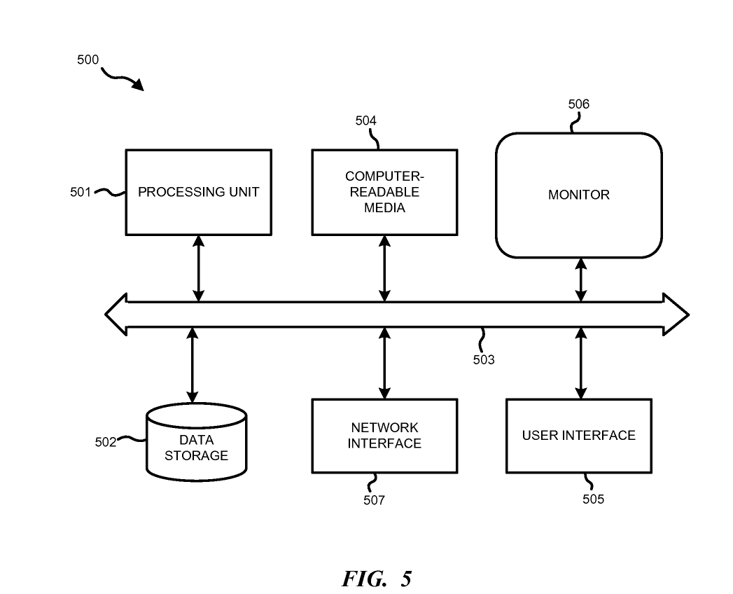

FIG. 4 is flowchart of a process for building a customizable dashboard according to one embodiment. In step 401, a plurality of visual control templates are provided in a visual tiles factory. In step 402, a user-configured visual control template is stored with bindings to back-end data and analytics and to a visualization for selected KPIs. In step 403, a visual control instance is instantiated having the back-end data, analytics, and visualization bindings configured in the visual control template.

In step 404, the visual control instance accesses the back-end data and analytics at runtime. In step 405, a visualization of the back-end data and analytics is provided as KPIs on a dashboard. In step 406, end-users may input data via the dashboard.

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 500. Components may include, but are not limited to, various hardware components, such as processing unit 501, data storage 502, such as a system memory, and system bus 503 that couples various system components including the data storage 502 to the processing unit 501. The system bus 503 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 500 typically includes a variety of computer-readable media 504. Computer-readable media 504 may be any available media that can be accessed by the computer 500 and includes both volatile and nonvolatile media, and removable and non-removable media, but excludes propagated signals. By way of example, and not limitation, computer-readable media 504 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 502 includes computer storage media in the form of volatile and/or nonvolatile memory such as read only memory (ROM) and random access memory (RAM). A basic input/output system (BIOS), containing the basic routines that help to transfer information between elements within computer 500, such as during start-up, is typically stored in ROM. RAM typically contains data and/or program modules that are immediately accessible to and/or presently being operated on by processing unit 501. By way of example, and not limitation, data storage 502 holds an operating system, application programs, and other program modules and program data.

Data storage 502 may also include other removable/non-removable, volatile/nonvolatile computer storage media. By way of example only, data storage 502 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 5, provide storage of computer-readable instructions, data structures, program modules and other data for the computer 500.

A user may enter commands and information through a user interface 505 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit 501 through a user input interface 505 that is coupled to the system bus 503, but may be connected by other interface and bus structures, such as a parallel port, game port or a universal serial bus (USB). A monitor 506 or other type of display device is also connected to the system bus 503 via an interface, such as a video interface. The monitor 506 may also be integrated with a touch-screen panel or the like. Note that the monitor and/or touch screen panel can be physically coupled to a housing in which the computing device 500 is incorporated, such as in a tablet-type personal computer. In addition, computers such as the computing device 500 may also include other peripheral output devices such as speakers and printer, which may be connected through an output peripheral interface or the like.

The computer 500 may operate in a networked or cloud-computing environment using logical connections 507 to one or more remote devices, such as a remote computer. The remote computer may be a personal computer, a server, a router, a network PC, a peer device or other common network node, and typically includes many or all of the elements described above relative to the computer 500. The logical connections depicted in FIG. 5 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 500 may be connected to a public or private network through a network interface or adapter 507. In some embodiments, a modem or other means for establishing communications over the network. The modem, which may be internal or external, may be connected to the system bus 503 via the network interface 507 or other appropriate mechanism. A wireless networking component such as comprising an interface and antenna may be coupled through a suitable device such as an access point or peer computer to a network. In a networked environment, program modules depicted relative to the computer 500, or portions thereof, may be stored in the remote memory storage device. It may be appreciated that the network connections shown are exemplary and other means of establishing a communications link between the computers may be used.

An example computer-implemented method comprises defining a custom data service by dynamically binding data feeds, analytics, and visual artifacts; and displaying the custom data service on a user interface dashboard. The custom data service may be displayed as a tile on the dashboard. The computer-implemented may further comprise configuring a visual control template by binding the visual control template to a data feed. The computer-implemented method may further comprise configuring a visual control template by binding the visual control template to parameters for visualizations. The computer-implemented method may further comprise configuring a visual control template by binding the visual control template to parameters for queries. The computer-implemented method may further comprise configuring a visual control template to accept runtime ad hoc data input from an end-user.

An example method for building a customizable dashboard comprises storing a visual control template with bindings to back-end data and analytics and to a visualization for selected KPIs; instantiating a visual control instance having the back-end data, analytics, and visualization bindings configured in the visual control template; accessing the back-end data and analytics at runtime; and providing visualization of the back-end data and analytics as KPIs on a dashboard. The method may further comprise receiving data input via the dashboard from end-users. The visual control instance may be instantiated by a visual tile factory. The dashboard may host multiple visual control instances.

An example system for building a customizable dashboard comprises at least one processor; and a memory coupled to the at least one processor, the memory having stored thereon computer-executable instructions that, upon execution by the at least one processor, cause the system to provide a plurality of pluggable visual tile templates, provide a binding service that connects the tile templates with business entities, wherein the business entities provide data sources and analytics, and provide one or more dashboard pages for displaying instances of the tile templates. The computer-executable instructions may further cause the system to provide user-selectable parameters for visualization of the instances of the tile templates. The computer-executable instructions may further cause the system to provide user-selectable parameters for queries on the data sources. The instances of the tile templates may be displayed as static tiles on the dashboard pages. The computer-executable instructions may further cause the system to receive end-user input via the dashboard pages.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
defining a custom data service by dynamically binding data feeds, analytics, and visual artifacts; and
displaying the custom data service on a user interface dashboard.

2. The computer-implemented method of claim 1, wherein the custom data service is displayed as a tile on the dashboard.

3. The computer-implemented method of claim 1, further comprising:
configuring a visual control template by binding the visual control template to a data feed.

4. The computer-implemented method of claim 1, further comprising:
configuring a visual control template by binding the visual control template to parameters for visualizations.

5. The computer-implemented method of claim 1, further comprising:
configuring a visual control template by binding the visual control template to parameters for queries.

6. The computer-implemented method of claim 1, further comprising:
configuring a visual control template to accept runtime ad hoc data input from an end-user.

7. A method for building a customizable dashboard, comprising:
storing a visual control template with bindings to back-end data and analytics and to a visualization for selected key performance indicators (KPIs);
instantiating a visual control instance having the back-end data, analytics, and visualization bindings configured in the visual control template;
accessing the back-end data and analytics at runtime; and
providing visualization of the back-end data and analytics as KPIs on a dashboard.

8. The method of claim 7, further comprising:
receiving data input via the dashboard from end-users.

9. The method of claim 7, wherein the visual control instance is instantiated by a visual tile factory.

10. The method of claim 7, wherein the dashboard hosts multiple visual control instances.

11. A system, comprising:
at least one processor; and
a memory coupled to the at least one processor, the memory having stored thereon computer-executable instructions that, upon execution by the at least one processor, cause the system to:
provide a plurality of pluggable visual tile templates;
provide a binding service that connects the tile templates with business entities, wherein the business entities provide data sources and analytics; and
provide one or more dashboard pages for displaying instances of the tile templates.

12. The system of claim 11, wherein the computer-executable instructions further cause the system to:
provide user-selectable parameters for visualization of the instances of the tile templates.

13. The system of claim 11, wherein the computer-executable instructions further cause the system to:
provide user-selectable parameters for queries on the data sources.

14. The system of claim 11, wherein the instances of the tile templates are displayed as static tiles on the dashboard pages.

15. The system of claim 11, wherein the computer-executable instructions further cause the system to:
receive end-user input via the dashboard pages.
